(19) United States
(12) Patent Application Publication
(10) Pub. No.: US 2005/0220518 A1
(43) Pub. Date: Oct. 6, 2005

(54) Treatment of preprinted media for improved toner adhesion

(75) Inventor: Alan R. Priebe, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/073,895

(22) Filed: Mar. 7, 2005

Related U.S. Application Data
(60) Provisional application No. 60/557,981, filed on Mar. 31, 2004.

(51) Int. Cl. G03G 15/00

(52) U.S. Cl. 399/390

(57) ABSTRACT

The present invention relates to surface treatment of printed media, and more particularly to surface treating media for improved toner adhesion, wherein the surface treatment includes corona discharge, plasma treatment, ozone treatment, UV treatment, electron-beam treatment and electron beam radiation, and the media is preprinted.

### RELATED APPLICATIONS

This application claims the benefit of the filing date of Provisional Application Ser. No. 60/557,981 entitled “TREATMENT OF PREPRINTED MEDIA FOR IMPROVED TONER ADHESION”.

### FIELD OF THE INVENTION

The present invention relates to surface treatment of printed media, and more particularly to surface treating media for improved toner adhesion.

### BACKGROUND

Corona discharge treatment of surfaces of articles made of thermoplastic polymers and electrical conductors is a known technique to enhance the surface adhesion of such articles.

Corona discharge devices for treating sheets of material generally comprise a pair of electrodes, at least one of which rotates. For example, U.S. Pat. No. 3,973,132 to Prinz discloses a corona discharge apparatus for treating non-conductive foils comprising a rotating electrode pair, the high-frequency voltage electrode having a profiled cross section, and the ground electrode being a smooth cylinder. When high voltage is applied to one of the electrodes, a corona discharge takes place through the air gap between the electrodes and onto the surfaces of the foil.

U.S. Pat. No. 4,273,635 to Beraud et al. discloses a process for corona treatment of bulky fibrous webs derived at least partially from thermoplastic fibers to impart cohesion to the webs. The process includes passing the webs between a pair of rotating cylindrical metallic electrodes.

U.S. Pat. No. 4,392,178 to Radice discloses an apparatus for enhancing the piezoelectric properties of polymeric films by corona treatment using a roller electrode mounted for movement along the circumference of a motorized, rotating drum which propels the film. The roller electrode moves in an oscillatory motion normal to the axis of rotation of the drum.

U.S. Pat. No. 3,435,190 to Schirmer discloses a corona discharge apparatus used to perforate films of dielectric material. The apparatus includes a stationary, blade-like electrode covered with electrically insulating materials along its length and another elongated, rotatable electrode, between which a sheet of the dielectric material passes.

Canadian Patent No. 790,038 to Adams discloses an apparatus for corona treatment of plastic films which conveys a sheet of such plastic film on a cylindrical, rotating roller which acts as one electrode, and passes close to a similarly contoured stationary electrode covered with a layer of dielectric material. The apparatus also has a locknut for adjusting electrode spacing.

U.S. Pat. No. 4,940,521 to Dinter et al. discloses apparatus for treating the surface of electrically conducting materials such as metal foil or plastic film containing conductive particles, by means of electrical corona discharge. The electrodes, which are covered by dielectric material, extend horizontally and are spaced from the surface to be treated. A housing encloses the electrodes and is connected to receive atomized liquid.

U.S. Pat. No. 4,940,894 to Morters is directed to an electrode for a corona discharge apparatus. The electrode includes a steel tube with a dielectric covering.

U.S. Pat. No. 4,879,100 to Tsutsui et al. and “Plasma Surface Treatment of Polypropylene-Containing Plastics”, Koichi Tsutsui et al., Journal of Coatings Technology, Vol. 61, No. 776, September 1989, are directed to corona discharge treatment apparatus for treating the surface of, for example, a plastic automobile bumper. The apparatus shown in the patent includes an electrode wire fitting member with a large number of electrode wires dependent therefrom for contacting the upper surface of the object to be treated. In FIG. 1a, the equipment is shown including a base electrode, which may be grounded and which is shaped to conform to the inside surface of the object to be treated.

U.S. Pat. No. 2,969,463 to McDonald shows apparatus for treating the surfaces of a plastic sheet. One of the fixed electrode assemblies, as shown in FIG. 3, is disposed spaced from a conductive roller on which the plastic sheet moves, with the fixed electrode being embedded in a coating of glass. FIG. 4 shows an alternative embodiment of the electrode assembly including a metal tube electrode disposed in a glass sleeve and terminating somewhat short of the end of the glass sleeve facing the moving plastic sheet. The electrode assembly is spaced from the moving plastic sheet.

U.S. Pat. No. 4,555,171 to Clouthier et al. illustrates a corona charging electrode including a plurality of metallic filaments. These filaments could have a diameter of approximately 0.001 inch. The device is for use in copying or printing apparatus.

U.S. Pat. No. 4,353,970 to Dryczynski et al. discloses apparatus for charging a dielectric layer. As shown in FIG. 10, the dc voltage electrode could include a number of individual metal wires which are held spaced apart and insulated with respect to one another between a pair of glass plates with each of the electrodes extending toward the layer beyond the plates.

All of the above are incorporated herein by reference.

Efforts in this area have led to continued improvements and developments.

### BRIEF DESCRIPTION OF THE DRAWINGS

FIG. 1a is a schematic diagram of a marking or reproduction engine in accordance with the present invention;

FIG. 1b is a schematic diagram of an electrographic marking or reproduction system in accordance with the present invention;

FIG. 2 is a simplified schematic diagram of a corona discharge treatment apparatus in accordance with the present invention; and

FIG. 3, similar to FIG. 1, shows the apparatus treating a strip of conductive material which is supported by spaced rollers.

FIG. 4 is a corona discharge treatment apparatus in accordance with the present invention

FIG. 5 is a printing flow method in accordance with the present invention.

### DETAILED DESCRIPTION

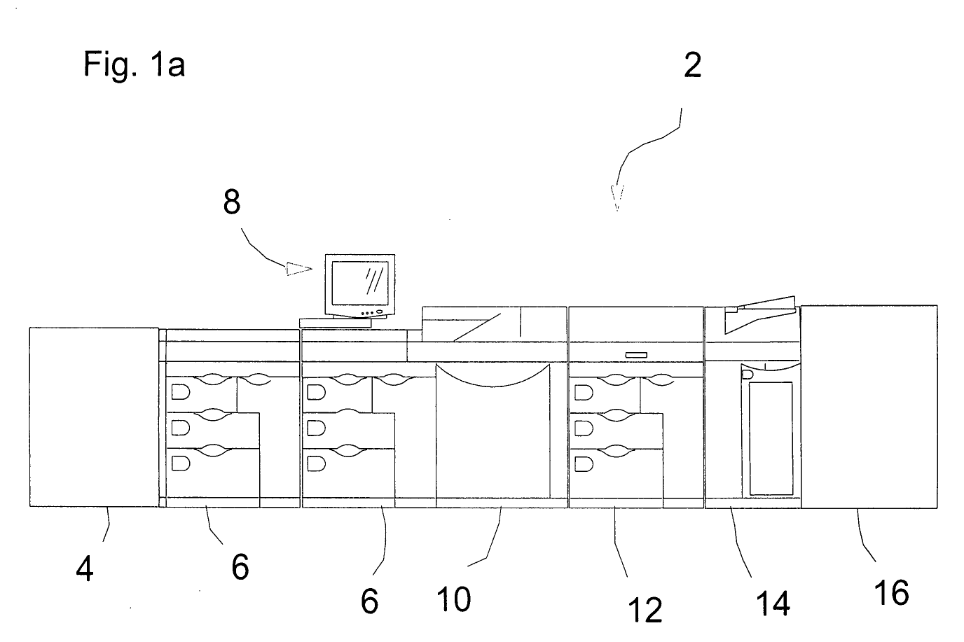

Referring now to FIG. 1a, wherein a print system 2 is comprised of a media treatment system 4 for treating media to be printed. Media may include paper, cardboard, plastic, metal sheets, or any of a number of materials to which a marking material is to be adhered to in a predefined pattern or image. The present invention the media may be “heavy” media, or other types of media which are considered hard to print on. Heavy media is media that is either thicker and/or more dense than media typically processed in the print engine. The treated media is provided to a marking engine 10. Media to be printed on is also referred to as a receiver. For exemplary purposes, a media supply 6 is shown, wherein the treated media, and perhaps other media is stacked in trays or otherwise organized. The print system is controlled via a user interface 8 which may be remotely located from the print engine 10. The printed media is supplied to a stacking device 12, 14 and/or a finishing device 16.

Referring to FIG. 1b, the printer or marking engine 10. Engine 10 prints by electrography, and is more specifically an electrostatographic printer, and includes a moving recording member such as a photoconductive belt 18 which is entrained about a plurality of rollers or other supports 21a through 21g, one or more of which is driven by a motor to advance the belt. By way of example, roller 21a is illustrated as being driven by motor 20. Motor 20 preferably advances the belt at a high speed, such as 20 inches per second or higher, in the direction indicated by arrow P, past a series of workstations of the printer 10. Alternatively, belt 18 may be wrapped and secured about only a single drum.

Printer 10 includes a controller or logic and control unit (LCU) 24, preferably a digital computer or microprocessor operating according to a stored program for sequentially actuating the workstations within printer 10, effecting overall control of printer 10 and its various subsystems. LCU 24 also is programmed to provide closed-loop control of printer 10 in response to signals from various sensors and encoders. Aspects of process control are described in U.S. Pat. No. 6,121,986 incorporated herein by this reference.

A primary charging station 28 in printer 10 sensitizes belt 18 by applying a uniform electrostatic corona charge, from high-voltage charging wires at a predetermined primary voltage, to a surface 18a of belt 18. The output of charging station 28 is regulated by a programmable voltage controller 30, which is in turn controlled by LCU 24 to adjust this primary voltage, for example by controlling the electrical potential of a grid and thus controlling movement of the corona charge. Other forms of chargers, including brush or roller chargers, may also be used.

An exposure station 34 in printer 10 projects light from a writer 34a to belt 18. This light selectively dissipates the electrostatic charge on photoconductive belt 18 to form a latent electrostatic image of the document to be copied or printed. Writer 34a is preferably constructed as an array of light emitting diodes (LEDs), or alternatively as another light source such as a laser or spatial light modulator. Writer 34a exposes individual picture elements (pixels) of belt 18 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

Image data to be printed is provided by an image data source 36, which is a device that can provide digital data defining a version of the image. Such types of devices are numerous and include computer or microcontroller, computer workstation, scanner, digital camera, etc. These data represent the location and intensity of each pixel that is exposed by the printer. Signals from data source 36, in combination with control signals from LCU 24 are provided to a raster image processor (RIP) 37. The Digital images (including styled text) are converted by the RIP 37 from their form in a page description language (PDL) language to a sequence of serial instructions for the electrographic printer in a process commonly known as “ripping” and which provides a ripped image to a image storage and retrieval system known as a Marking Image Processor (MIP) 38.

In general, the major roles of the RIP 37 are to: receive job information from the server; Parse the header from the print job and determine the printing and finishing requirements of the job; Analyze the PDL (Page Description Language) to reflect any job or page requirements that were not stated in the header; Resolve any conflicts between the requirements of the job and the Marking Engine configuration (i.e., RIP time mismatch resolution); Keep accounting record and error logs and provide this information to any subsystem, upon request; Communicate image transfer requirements to the Marking Engine; Translate the data from PDL (Page Description Language) to Raster for printing; and Support Diagnostics communication between User Applications The RIP accepts a print job in the form of a Page Description Language (PDL) such as PostScript, PDF or PCL and converts it into Raster, a form that the marking engine can accept. The PDL file received at the RIP describes the layout of the document as it was created on the host computer used by the customer. This conversion process is called rasterization. The RIP makes the decision on how to process the document based on what PDL the document is described in. It reaches this decision by looking at the first 2K of the document. A job manager sends the job information to a MSS (Marking Subsystem Services) via Ethernet and the rest of the document further into the RIP to get rasterized. For clarification, the document header contains printer-specific information such as whether to staple or duplex the job. Once the document has been converted to raster by one of the interpreters, the Raster data goes to the MIP 38 via RTS (Raster Transfer Services); this transfers the data over a IDB (Image Data Bus).

The MIP functionally replaces recirculating feeders on optical copiers. This means that images are not mechanically rescanned within jobs that require rescanning, but rather, images are electronically retrieved from the MIP to replace the rescan process. The MIP accepts digital image input and stores it for a limited time so it can be retrieved and printed to complete the job as needed. The MIP consists of memory for storing digital image input received from the RIP. Once the images are in MIP memory, they can be repeatedly read from memory and output to the Render Circuit. The amount of memory required to store a given number of images can be reduced by compressing the images; therefore, the images are compressed prior to MIP memory storage, then decompressed while being read from MIP memory.

The output of the MIP is provided to an image render circuit 39, which alters the image and provides the altered image to the writer interface 32 (otherwise known as a write head, print head, etc.) which applies exposure parameters to the exposure medium, such as a photoconductor 18.

After exposure, the portion of exposure medium belt 18 bearing the latent charge images travels to a development station 35. Development station 35 includes a magnetic brush in juxtaposition to the belt 18. Magnetic brush development stations are well known in the art, and are preferred in many applications; alternatively, other known types of development stations or devices may be used. Plural development stations 35 may be provided for developing images in plural colors, or from toners of different physical characteristics. Full process color electrographic printing is accomplished by utilizing this process for each of four toner colors (e.g., black, cyan, magenta, yellow).

Upon the imaged portion of belt 18 reaching development station 35, LCU 24 selectively activates development station 35 to apply toner to belt 18 by moving backup roller 35a belt 18, into engagement with or close proximity to the magnetic brush. Alternatively, the magnetic brush may be moved toward belt 18 to selectively engage belt 18. In either case, charged toner particles on the magnetic brush are selectively attracted to the latent image patterns present on belt 18, developing those image patterns. As the exposed photoconductor passes the developing station, toner is attracted to pixel locations of the photoconductor and as a result, a pattern of toner corresponding to the image to be printed appears on the photoconductor. As known in the art, conductor portions of development station 35, such as conductive applicator cylinders, are biased to act as electrodes. The electrodes are connected to a variable supply voltage, which is regulated by programmable controller 40 in response to LCU 24, by way of which the development process is controlled.

Development station 35 may contain a two component developer mix which comprises a dry mixture of toner and carrier particles. Typically the carrier preferably comprises high coercivity (hard magnetic) ferrite particles. As an example, the carrier particles have a volume-weighted diameter of approximately 30μ. The dry toner particles are substantially smaller, on the order of 6μ to 15μ in volume-weighted diameter. Development station 35 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to photoconductive belt 18 to develop the electrostatic images thereon and the carrier material remains at development station 35. As toner is depleted from the development station due to the development of the electrostatic image, additional toner is periodically introduced by toner auger 42 into development station 35 to be mixed with the carrier particles to maintain a uniform amount of development mixture. This development mixture is controlled in accordance with various development control processes. Single component developer stations, as well as conventional liquid toner development stations, may also be used. Examples of developers and toners for use in such systems are described in U.S. Pat. Nos. 6,797,448 and 6,610,451, the contents of which are hereby incorporated herein by reference. The toner particles that are used in the development system preferably contain at least one toner resin, at least one release agent, at least one surface treatment agent, and optionally at least one colorant, at least one charge control agent, other conventional toner components, or combinations thereof. The use of these toner particles in combination with the particular development system described herein results in an image which has improved image quality along with excellent fusing quality.

The set up of the development system is preferably a digital printer, such as a Heidelberg Digimaster 9110 printer using a development station comprising a non-magnetic, cylindrical shell, a magnetic core, and means for rotating the core and optionally the shell as described, for instance, in detail in U.S. Pat. Nos. 4,473,029 and 4,546,060, both incorporated in their entirety herein by reference. The development systems described in these patents can be adapted for use in the present invention. In more detail, the development systems described in these patents preferably use hard magnetic carrier particles. For instance, the hard magnetic carrier particles can exhibit a coercivity of at least about 300 gauss when magnetically saturated and also exhibit an induced magnetic moment of at least about 20 EMU/gm when in an externally applied field of 1,000 gauss. The magnetic carrier particles can be binder-less carriers or composite carriers. Useful hard magnetic materials include ferrites and gamma ferric oxide. Preferably, the carrier particles are composed of ferrites, which are compounds of magnetic oxides containing iron as a major metallic component. For example, compounds of ferric oxide, Fe.sub.2 O.sub.3, formed with basic metallic oxides such as those having the general formula MFeO.sub.2 or MFe.sub.2 O.sub.4 wherein M represents a mono- or di-valent metal and the iron is in the oxidation state of +3. Preferred ferrites are those containing barium and/or strontium, such as BaFe.sub.12 O.sub.19, SrFe.sub.12 O.sub.19, and the magnetic ferrites having the formula MO.6 Fe.sub.2 O.sub.3, wherein M is barium, strontium, or lead as disclosed in U.S. Pat. No. 3,716,630 which is incorporated in its entirety by reference herein. The size of the magnetic carrier particles useful in the present invention can vary widely, and preferably have an average particle size of less than 100 microns, and more preferably have an average carrier particle size of from about 5 to about 45 microns.

In order to overcome these difficulties, there are several solutions. One solution is to use surface treated toner particles. The surface treatment with a surface treatment agent or a spacing agent reduces the attraction between the toner particles and the hard magnetic carrier particles to a degree sufficient that the toner particles are transported by the carrier particles to the development zone where the electrostatic image is present and then the toner particles leave the carrier particles due at least in part to the sufficient electrostatic forces associated with the charged image. Accordingly, the toner particles permit attraction with the magnetic carrier particles but further permit the stripping of the toner particles from the hard magnetic carrier particles by the electrostatic and/or mechanical forces and with surface treatment on the toner particles. In other words, the spacing agent on the surface of the toner particles, as indicated above, is sufficient to reduce the attraction between the toner particles and the hard magnetic carrier particles such that the toner particles can be stripped from the carrier particles by the electrostatic forces associated with the charged image or by mechanical forces.

The spacing agent may be silica, such as those commercially available from Degussa, like R-972, or from Wacker, like H2000. Other suitable spacing agents include, but are not limited to, other inorganic oxide particles and the like. Specific examples include, but are not limited to, titania, alumina, zirconia, and other metal oxides; and also polymer beads preferably less than 1.mu.m in diameter (more preferably about 0.1.mu.m), such as acrylic polymers, silicone-based polymers, styrenic polymers, fluoropolymers, copolymers thereof, and mixtures thereof.

The amount of the spacing agent on the toner particles is an amount sufficient to permit the toner particles to be stripped from the magnetic carrier particles by the electrostatic forces associated with the charged image or by mechanical forces. Preferred amounts of the spacing agent are from about 0.05 to about 2.0 wt %, and more preferably from about 0.1 to about 1.0 wt %, and most preferably from about 0.2 to about 0.6 wt %, based on the weight of the toner.

The spacing agent can be applied onto the surfaces of toner particles by conventional surface treatment techniques such as, but not limited to, conventional mixing techniques, such as tumbling the toner particles in the presence of the spacing agent. Preferably, the spacing agent is distributed on the surface of the toner particles. The spacing agent is attached onto the surface of the toner particles and can be attached by electrostatic forces or physical means or both. With mixing, preferably uniform mixing is preferred and achieved by such mixers as a high energy Henschel-type mixer which is sufficient to keep the spacing agent from agglomerating or at least minimizes agglomeration. Furthermore, when the spacing agent is mixed with the magnetic toner particles in order to achieve distribution on the surface of the toner particles, the mixture can be sieved to remove any agglomerated spacing agent. Other means to separate agglomerated particles can also be used for purposes of the present invention.

In the present invention, at least one release agent is preferably present in the toner formulation. An example of a suitable release agent is one or more waxes. Useful release agents are well known in this art. Useful release agents include low molecular weight polypropylene, natural waxes, low molecular weight synthetic polymer waxes, commonly accepted release agents, such as stearic acid and salts thereof, and others.

The wax is preferably present in an amount of from about 0.1 to about 10 wt % and more preferably in an amount of from about 0.5 to about 5 wt % based on the toner weight. Examples of suitable waxes include, but are not limited to, polyolefin waxes, such as low molecular weight polyethylene, polypropylene, copolymers thereof and mixtures thereof. In more detail, more specific examples are copolymers of ethylene and propylene preferably having a molecular weight of from about 1000 to about 5000 g/mole, particularly a copolymer of ethylene and propylene having a molecular weight of about 1200 g/mole. Additional examples include synthetic low molecular weight polypropylene waxes preferably having a molecular weight from about 3,000 to about 15,000 g/mole, such as a polypropylene wax having a molecular weight of about 4000 g/mole. Other suitable waxes are synthetic polyethylene waxes. Suitable waxes are waxes available from Mitsui Petrochemical, Baker Petrolite, such as Polywax 2000, Polywax 3000, and/or Unicid 700; and waxes from Sanyo Chemical Industries such as Viscol 550P and/or Viscol 660P. Other examples of suitable waxes include waxes such as Licowax PE130 from Clarient Corporation.

The toner particles can include one or more toner resins which can be optionally colored by one or more colorants by compounding the resin(s) with at least one colorant and any other ingredients. Although coloring is optional, normally a colorant is included and can be any of the materials mentioned in Colour Index, Volumes I and II, Second Edition, incorporated herein by reference. The toner resin can be selected from a wide variety of materials including both natural and synthetic resins and modified natural resins as disclosed, for example, in U.S. Pat. Nos. 4,076,857; 3,938,992; 3,941,898; 5,057,392; 5,089,547; 5,102,765; 5,112,715; 5,147,747; 5,780,195 and the like, all incorporated herein by reference. Preferred resin or binder materials include polyesters and styrene-acrylic copolymers. The shape of the toner particles can be any shape, regular or irregular, such as spherical particles, which can be obtained by spray-drying a solution of the toner resin in a solvent. Alternatively, spherical particles can be prepared by the polymer bead swelling techniques, such as those described in European Patent No. 3905 published Sep. 5, 1979, which is incorporated in its entirety by reference herein.

Typically, the amount of toner resin present in the toner formulation is from about 80% to about 95% by weight of the toner formulation.

In a typical manufacturing process, the desired polymeric binder for toner application is produced. Polymeric binders for electrostatographic toners are commonly made by polymerization of selected monomers followed by mixing with various additives and then grinding to a desired size range. During toner manufacturing, the polymeric binder is subjected to melt processing in which the polymer is exposed to moderate to high shearing forces and temperatures in excess of the glass transition temperature of the polymer. The temperature of the polymer melt results, in part, from the frictional forces of the melt processing. The melt processing includes melt-blending of toner addenda into the bulk of the polymer.

The polymer may be made using a limited coalescence reaction such as the suspension polymerization procedure disclosed in U.S. Pat. No. 4,912,009 to Amering et al., which is incorporated in its entirety by reference herein.

Useful binder polymers include vinyl polymers, such as homopolymers and copolymers of styrene. Styrene polymers include those containing 40 to 100 percent by weight of styrene, or styrene homologs, and from 0 to 40 percent by weight of one or more lower alkyl acrylates or methacrylates. Other examples include fusible styrene-acrylic copolymers that are covalently lightly crosslinked with a divinyl compound such as divinylbenzene. Binders of this type are described, for example, in U.S. Reissue Pat. No. 31,072, which is incorporated in its entirety by reference wherein. Preferred binders comprise styrene and an alkyl acrylate and/or methacrylate and the styrene content of the binder is preferably at least about 60% by weight.

Copolymers rich in styrene such as styrene butylacrylate and styrene butadiene are also useful as binders as are blends of polymers. In such blends, the ratio of styrene butylacrylate to styrene butadiene can be 10:1 to 1:10. Ratios of 5:1 to 1:5 and 7:3 are particularly useful. Polymers of styrene butylacrylate and/or butylmethacrylate (30 to 80% styrene) and styrene butadiene (30 to 80% styrene) are also useful binders.

Styrene polymers include styrene, alpha-methylstyrene, para-chlorostyrene, and vinyl toluene; and alkyl acrylates or methylacrylates or monocarboxylic acids having a double bond selected from acrylic acid, methyl acrylate, 2-ethylhexyl acrylate, 2-ethylhexyl methacrylate, ethyl acrylate, butyl acrylate, dodecyl acrylate, octyl acrylate, phenylacrylate, methylacrylic acid, ethyl methacrylate, butyl methacrylate and octyl methacrylate and are also useful binders. Also useful are condensation polymers such as polyesters and copolyesters of aromatic dicarboxylic acids with one or more aliphatic diols, such as polyesters of isophthalic or terephthalic acid with diols such as ethylene glycol, cyclohexane dimethanol, and bisphenols.

A useful binder can also be formed from a copolymer of a vinyl aromatic monomer; a second monomer selected from either conjugated diene monomers or acylate monomers such as alkyl acrylate and alkyl methacrylate.

The term “charge-control” refers to a propensity of a toner addendum to modify the triboelectric charging properties of the resulting toner. A very wide variety of optional charge control agents for positive and negative charging toners are available and can be used in the toners of the present invention. Suitable charge control agents are disclosed, for example, in U.S. Pat. Nos. 3,893,935; 4,079,014; 4,323,634; 4,394,430; and British Patent Nos. 1,501,065 and 1,420,839, all of which are incorporated in their entireties by reference herein. Additional charge control agents which are useful are described in U.S. Pat. Nos. 4,624,907; 4,814,250; 4,840,864; 4,834,920; 4,683,188; and 4,780,553, all of which are incorporated in their entireties by reference herein. Mixtures of charge control agents can also be used. Particular examples of charge control agents include chromium salicylate organo-complex salts, and azo-iron complex-salts, an azo-iron complex-salt, particularly ferrate (1-), bis[4-[(5-chloro-2-hydroxyphenyl)azo]-3-hydroxy-N-phenyl-2-naphthalenecarb oxamidato(2-)], ammonium, sodium, and hydrogen (Organoiron available from Hodogaya Chemical Company Ltd.).

An optional additive for the toner is a colorant. In some cases the magnetic component, if present, acts as a colorant negating the need for a separate colorant. Suitable dyes and pigments are disclosed, for example, in U.S. Reissue Pat. No. 31,072 and in U.S. Pat. Nos. 4,160,644; 4,416,965; 4,414,152; and 2,229,513, all incorporated in their entireties by reference herein. One particularly useful colorant for toners to be used in black and white electrostatographic copying machines and printers is carbon black. Colorants are generally employed in the range of from about 1 to about 30 weight percent on a total toner powder weight basis, and preferably in the range of about 2 to about 15 weight percent. The toner formulations can also contain other additives of the type used in conventional toners, including magnetic pigments, colorants, leveling agents, surfactants, stabilizers, and the like.

The remaining components of toner particles as well as the hard magnetic carrier particles can be conventional ingredients. For instance, various resin materials can be optionally used as a coating on the hard magnetic carrier particles, such as fluorocarbon polymers like poly(tetrafluoro ethylene), poly(vinylidene fluoride) and polyvinylidene fluoride-co-tetrafluoroethlyene). Examples of suitable resin materials for the carrier particles include, but are not limited to, silicone resin, fluoropolymers, polyacrylics, polymethacrylics, copolymers thereof, and mixtures thereof, other commercially available coated carriers, and the like.

Magnetic ink character recognition (MICR) printing may also be used. MICR has been used for many years for checks and negotiable documents as well as for other documents in need of high speed reading and sorting. Various electrophotographic printers which are capable of printing magnetic inks or toners. The magnetic toner particles of the present invention preferably contain at least one type of magnetic material such as soft iron oxide (Fe.sub.3 O.sub.4) which is dispersed in the toner or ink and thus makes the toner or ink ferromagnetic. The soft iron oxide can be cubic and/or acicular. Other suitable magnetic materials can be present in the toner. The amount of the magnetic material in the magnetic toner particles can be any amount sufficient to preferably meet commercial needs, such as providing a signal strength for the imaged toners for an IBM 3828 MICR printer of from about 120% to about 140% average signal strength of the “on-us” characters as measured on a DOCU-MATE Check Reader. Depending on the equipment, the signal strength can be from about 80% to about 200%. Accordingly, there is preferably a sufficient amount of magnetic material in the toner to cause the imaged toner to have signal strength of about 100% or greater. Examples of preferred amounts of magnetic loadings are less than 28% by weight of the toner particles. More preferably, the magnetic loadings in the toner are from about 10% or less to about 24% by weight of the toner and even more preferably from about 16% to about 22% by weight of the toner. These amounts, especially the more preferred ranges, are significantly below magnetic loadings in commercially available magnetic MICR toners which use large amounts of magnetic loadings in order to achieve the necessary signal strengths for the released toner.

A transfer station 46 in marking engine 10 moves a receiver sheet S into engagement with photoconductive belt 18, in registration with a developed image to transfer the developed image to receiver sheet S. Receiver sheets S may be plain or coated paper, plastic, or another medium capable of being handled by printer 10. Typically, transfer station 46 includes a charging device for electrostatically biasing movement of the toner particles from belt 18 to receiver sheet S. In this example, the biasing device is roller 46b, which engages the back of sheet S and which is connected to programmable voltage controller 46a that operates in a constant current mode during transfer. Alternatively, an intermediate member may have the image transferred to it and the image may then be transferred to receiver sheet S. After transfer of the toner image to receiver sheet S, sheet S is detacked from belt 18 and transported to fuser station 49 where the image is fixed onto sheet S, typically by the application of heat. Alternatively, the image may be fixed to sheet S at the time of transfer.

A cleaning station 48, such as a brush, blade, or web is also located behind transfer station 46, and removes residual toner from belt 18. A pre-clean charger (not shown) may be located before or at cleaning station 48 to assist in this cleaning. After cleaning, this portion of belt 18 is then ready for recharging and re-exposure. Of course, other portions of belt 18 are simultaneously located at the various workstations of marking engine 10, so that the printing process is carried out in a substantially continuous manner.

LCU 24 provides overall control of the apparatus and its various subsystems as is well known. LCU 24 will typically include temporary data storage memory, a central processing unit, timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to marking engine 10, or received from sources external to marking engine 10, such from as a human user or a network control. The output data and control signals from LCU 24 are applied directly or through storage latches to suitable output drivers and in turn to the appropriate subsystems within marking engine 10.

Process control strategies generally utilize various sensors to provide real-time closed-loop control of the electrostatographic process so that marking engine 10 generates “constant” image quality output, from the user's perspective. Real-time process control is necessary in electrographic printing, to account for changes in the environmental ambient of the photographic printer, and for changes in the operating conditions of the printer that occur over time during operation (rest/run effects). An important environmental condition parameter requiring process control is relative humidity, because changes in relative humidity affect the charge-to-mass ratio Q/m of toner particles. The ratio Q/m directly determines the density of toner that adheres to the photoconductor during development, and thus directly affects the density of the resulting image. System changes that can occur over time include changes due to aging of the printhead (exposure station), changes in the concentration of magnetic carrier particles in the toner as the toner is depleted through use, changes in the mechanical position of primary charger elements, aging of the photoconductor, variability in the manufacture of electrical components and of the photoconductor, change in conditions as the printer warms up after power-on, triboelectric charging of the toner, and other changes in electrographic process conditions. Because of these effects and the high resolution of modern electrographic printing, the process control techniques have become quite complex.

Process control sensor may be a densitometer 76, which monitors test patches that are exposed and developed in non-image areas of photoconductive belt 18 under the control of LCU 24. Densitometer 76 may include a infrared or visible light LED, which either shines through the belt or is reflected by the belt onto a photodiode in densitometer 76. These toned test patches are exposed to varying toner density levels, including full density and various intermediate densities, so that the actual density of toner in the patch can be compared with the desired density of toner as indicated by the various control voltages and signals. These densitometer measurements are used to control primary charging voltage VO, maximum exposure light intensity EO, and development station electrode bias VB. In addition, the process control of a toner replenishment control signal value or a toner concentration setpoint value to maintain the charge-to-mass ratio Q/m at a level that avoids dusting or hollow character formation due to low toner charge, and also avoids breakdown and transfer mottle due to high toner charge for improved accuracy in the process control of marking engine 10. The toned test patches are formed in the interframe area of belt 18 so that the process control can be carried out in real time without reducing the printed output throughput. Another sensor useful for monitoring process parameters in printer 10 is electrometer probe 50, mounted downstream of the corona charging station 28 relative to direction P of the movement of belt 18. An example of an electrometer is described in U.S. Pat. No. 5,956,544 incorporated herein by this reference.

Other approaches to electrographic printing process control may be utilized, such as those described in International Publication Number WO 02/10860 A1, and International Publication Number WO 02/14957 A1, both commonly assigned herewith and incorporated herein by this reference.

Raster image processing begins with a page description generated by the computer application used to produce the desired image. The Raster Image Processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Half-tone densities are formed by the application of a halftone “screen” to the byte map, especially in the case of image objects to be printed. Pre-press adjustments can include the selection of the particular halftone screens to be applied, for example to adjust the contrast of the resulting image.

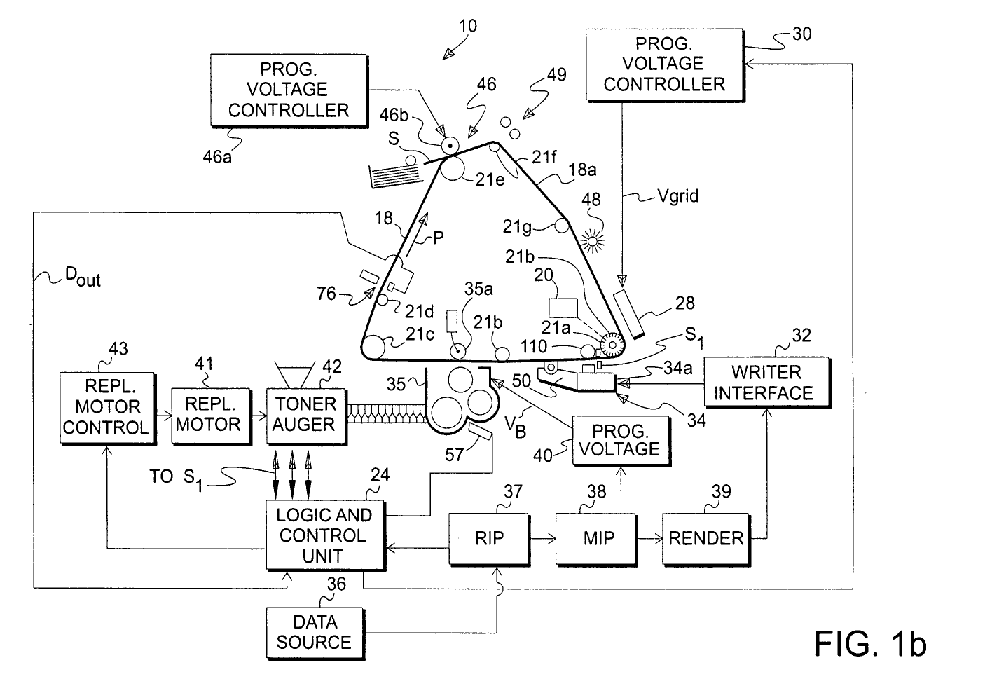

Referring now to FIG. 2, a corona discharge treatment system 108 is provided in the media treatment apparatus 4, which supplies the media to the print engine 10. Corona discharge treatment system 108 treats the surface of a receiver 112, such as a cut sheet of preprinted media that is to be later fed into the marking engine 10 for further printing. Preprinted media is print media that has images already deposited thereon. The images are created by the deposition of marking material on the receiver. Such marking material may be any of a number of well known marking materials, such as toner, inks, magnetic ink character recognition inks, limited coalescent toners, paints, etc. Subsequent printing of variable information, for instance by using a digital printer, may be desired. Corona discharge treatment system 8 can be used in applying many treatments of the surface of the print media. Corona discharge treatment changes the surface energy of the receiver to enhance the adhesion of toner thereto.

An example of surface treatment involves a receiver 112 disposed on a rotating roller apparatus 110 comprised of a rubber dielectric outer layer 114, which is disposed on a metal core 116, which is disposed on a metal gudgeon face 118, which is disposed on a metal gudgeon journal 120 which is grounded via a line 119.

A plurality of electrodes 121-124 are positioned in close proximity to the roller 110 and supplied high voltage from a high voltage supply 128 through a line 130. The electrodes 121-124 and roller 110 are disposed in an enclosure 132. A gas supply 134 transmits gas into the enclosure 132 through a line 136.

The receiver is corona discharge treated using any suitable method and apparatus known in the art. The term “corona-discharge treated” is used herein to refer to processes which involve generation of an electrical discharge wherein the resulting plasma or corona is impinged upon the surface of the metal support to be treated. The resulting treated surface generally exhibits increased surface energy and improved adhesive properties. The surface treatment processes and equipment for such treatment include, but are not limited to, those described in U.S. Pat. No. 5,466,423 (Brinton et al), U.S. Pat. No. 5,194,291 (D'Aoust et al) and U.S. Pat. No. 4,649,097 (Tsukada et al), all incorporated herein by reference. Currently preferred are conventional corona discharge treatment techniques that utilize a power supply and electrode assembly. Convenient treatment units are those supplied by Enercon Industries Corp., ENI Power Systems, or Corotec Corp. It is preferred that the corona discharge treatment is applied to the support at atmospheric pressure and in ambient air. The electrode geometry can be readily chosen or tailored to meet the needs of the process, depending upon the shape of the metal support, as one skilled in the art would understand. In a preferred embodiment, the metal supports are round cores and thus the electrode geometry was arranged to uniformly treat the circular outer surface of the cores.

Important variables in carrying out the present invention are the time and power level of corona discharge treatment. It has been found that there are wide ranges of these variables useful in the present invention.

The power level for the corona discharge treatment should be adequate to sufficiently activate the surface in a reasonable amount of time. The power level and treatment time for sufficient activation of the surface of the metal are inversely related. Generally, the power level should be between about 200 to about 1200 watts, more preferably from about 300 to about 1000 watts, and most preferably from about 750 to about 850 watts. The treatment times are generally from about 10 to about 200 seconds, preferably from about 15 to about 150 seconds and most preferably from about 70 to about 110 seconds. However, it should be understood from the previously discussion, that power levels and treatment times outside these ranges can be found useful with routine experimentation and the proper power supply and electrode assembly.

A suitable combination of corona discharge treatment features includes a power level of from about 750 to about 850 watts for a time of from about 70 to about 110 seconds. High voltage supply 128 may be a high voltage, high RF power supply. The output voltage of the power supply 128 is preferably greater than 5 kV and is most preferably about 10 kV, while the output frequency of the power supply is preferably greater than 500 kHz and is most preferably about 13 MHz or higher. Higher frequencies help to stabilize the atmospheric pressure “glow” plasma discharge. This may be important when a high percentage of hydrogen gas is used in the plasma discharge. An unstable plasma is not desired because it tends to transition into an arc-style discharge that produces a filamentary structure that is non uniform. As indicated above, a high frequency is required to stabilize the atmospheric glow or corona plasma discharge.

The roller 110, receiver 121 and receiver 112 are contained within an enclosure 132 during treatment, and immersed in a gaseous environment supplied by a gas supply 134. Typically, the gases used include air, dried air, nitrogen, oxygen, ozone, carbon dioxide, ammonia, hydrocarbon gases, inert gases (helium, neon, argon, etc.), or mixtures thereof. The preferred mixture of the gases is air, within a relative humidity range of about 10% to 60%, because of the benefits of low cost and low environmental concerns for emission. Gas mixtures which are more effective than air include oxidizing mixtures, particularly ozone, either as a portion or as the only component of the gas mixture. However, the costs associated with generating, containing, and exhausting or destroying large amounts of ozone are generally prohibitive for an application such as this, and limit the use of ozone to small fractions of the gas mixture. A suitable rate of rotation for the roller while treating a receiver is about 2.5 sec per rotation with a power level of about 680 watts minimum and a total rotation time of about 80 sec with corona treatment (about 32 rotations through the corona electrodes). A suitable temperature is about 70° F., but treatment is generally faster and more effective at higher temperature. This can be achieved by temporarily heating the media before or during treatment, especially by the corona or plasma treatment itself, or by the addition of heated contacting surfaces (such as the support rollers), blowing heated gases on the surface, or providing radiant heat such as from an incandescent lamp filament, gas discharge tube, or solid state emitter. The media may then be cooled to prevent undesirable effects of temperature, such as smearing or transfer of inks to other sheets.

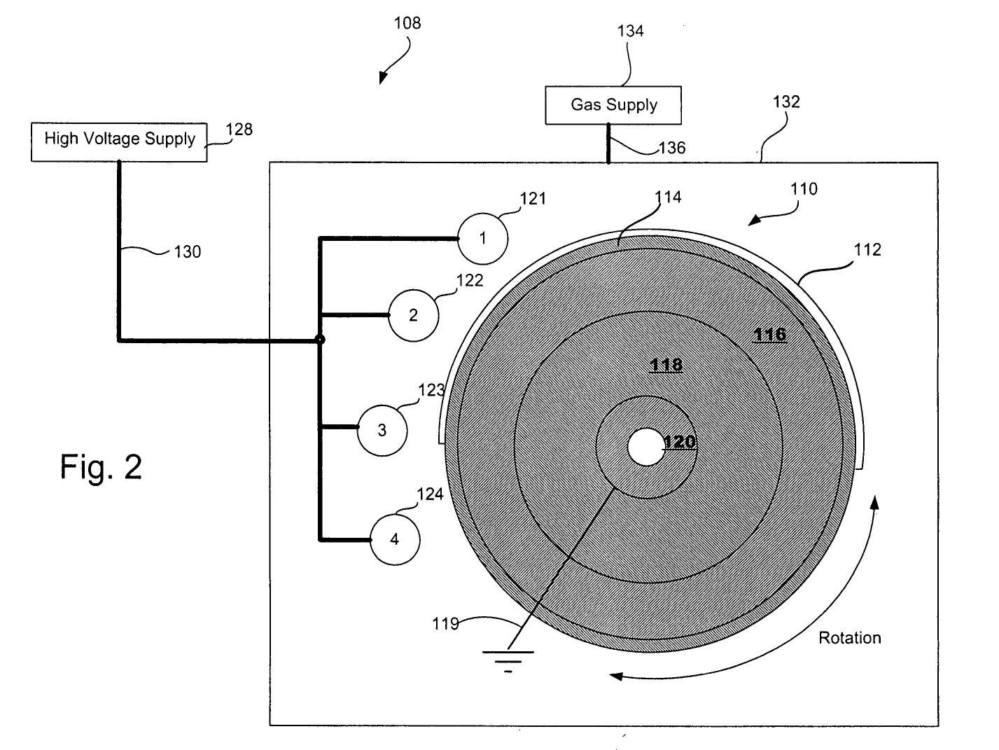

Referring now to FIG. 3, there is shown a typical electrode 121-124 comprised of a quartz tube 210 disposed over a metal tube electrode 212. The quartz tube 210 and metal tube electrode 212 are separated by insulating supports or spacers 214 to thereby create a gap 216 therebetween. A gas supply 220 supplies gas into the gap 216 through a line 222. The gas is exhausted out through a line 224 to an exhaust 226.

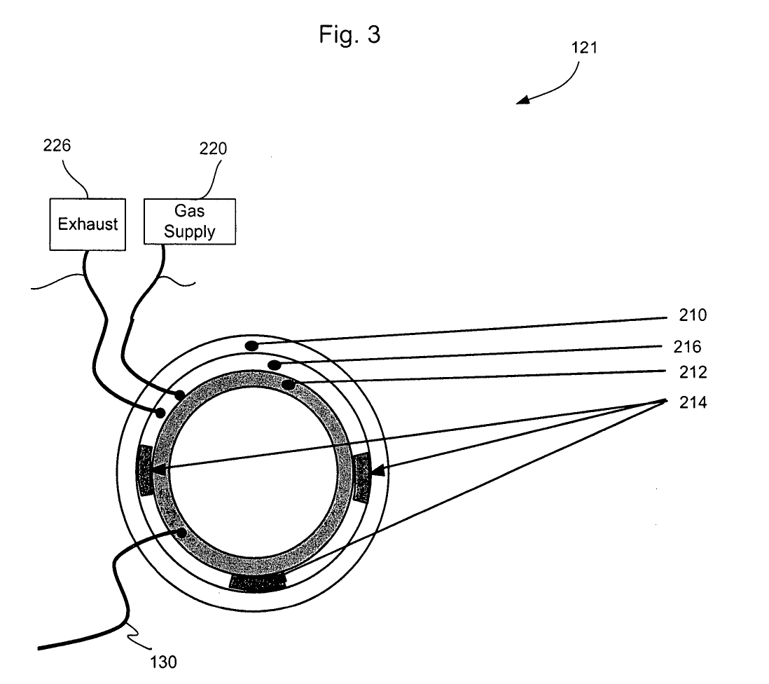

FIG. 4 shows an alternative embodiment of the corona discharge treatment apparatus of the present invention where the receiver 112′ moves across or in the longitudinal direction between four rollers 110′ and electrodes 121′-124′, respectively.

The media treatment apparatus 108 provided in a media treatment center 4 of the present invention treats the surface of media before it is printed. Although the center 4 is shown as being operatively connected to a printing system, it may be remote from the printer. To this end, the media may be surface treated well in advance of the subsequent printing operation. It has been found that the treatment may be administered to the media hours, and perhaps days before printing, depending to some extent upon the degree of dryness of the marking material printed thereon. Also, other types of surface treatments other than corona discharge may be utilized to treat the media. Examples of alternative treatments include plasma, ozone, electron-beam, UV, heat, etc.

Plasma treatment, included in the description above, usually differs from corona treatment by the location of the electrodes, which are used to create the electrical discharge, relative to the media to be treated. Rather than sandwiching the media between two or more electrodes and creating a discharge with an electric field through the media as in corona discharge, in plasma treatment, the electrodes can be situated such that the electrical discharge occurs on one side of the media, and is impinged upon the surface of the media. Plasma treatment can be done at reduced gas pressure (less than atmospheric pressure), but atmospheric pressure is more practical, since air-tight seals and vacuum pumps are not then required. Plasma treatment is usually done with smaller electrodes and hence a smaller width of treatment area, which then requires moving the treatment electrodes across the media surface, or ganging of many pairs of electrodes to treat practical widths of media. An advantage of plasma treatment can be reduced ozone generation by better control of the voltage and current flow than in corona treatment. Other advantages include the ability to treat media which are too thick, too conductive, too variable in width, or for any other reason would create non-uniformity or interruption of the corona discharge, such as due to limitations of voltage which can be generated.

Ozone treatment may be used to modify the media surface with a high concentration of ozone in the gas stream around the media. It is generally preferred for use on objects or surfaces which are irregular in thickness or shape, because it gives a more uniform treatment by enveloping whatever is in the chamber containing the ozone gas. It has the disadvantages discussed above, in terms of cost and environmental concerns, but is also generally a somewhat slower process than corona or plasma treatment.

UV treatment may be used to modify the media surface by exposing it to ultraviolet radiation for a sufficient length of time. Ultraviolet light spans the range of wavelengths from about 10-400 nanometers, but the regions of more practical importance include UV-A (400-320 nm) and UV-B (320-290). The UV light source is generally an electrical discharge in a gas-filled lamp envelope, usually filled with mercury vapor, and may include one or more filters to remove some wavelengths of light, either for safety, or for the effect on the article or media being exposed. UV light exposure for extended periods of time has a well-known effect on aging materials, seen by effects such as fading of colorants, embrittlement of organic materials such as plastics, and yellowing of some materials such as paper, plastic, etc. In addition, UV light has well known health effects, especially the shorter wavelength, higher energy UV-A form. For this reason, UV light must be used in completely shielded or baffled chambers, with suitable interlocks to minimize human exposure while in operation. Nevertheless, UV light is a method which accelerates chemical reactions, and is employed to modify surfaces, particularly to cure materials, including such materials as specially-formulated UV-curable inks. Suitable media treatment times and energy levels for treatment vary widely, depending on the types of media, ink type, coverage, and level of drying of the inks on the printed media. Gases can be used to blanket the media being treated, as is done with nitrogen purging to remove oxygen and accelerate UV-curable ink systems.

Electron-beam treatment may be used to modify the media surface and is a method involving generation of electrons, acceleration of electrons under an electric field, and directing the electrons over a desired area to be treated by diverging or scanning the beam in a raster using various techniques such as varying electric or magnetic fields. Electron energies required are typically in about the 1 MeV or higher energy range, with beam current levels sufficient to provide enough power density to the area of media being treated. Electron beam treatment is similar to UV treatment in the respect of providing energy to accelerate chemical reactions, and hence modify surfaces by promoting curing or generating reactive species on the surface.

Electron beam radiation, like UV, also has health effects and so appropriate guards, baffles, and interlocks must be employed in such treatment systems. Also, secondary emission of x-rays from bombardment of surfaces with high energy electrons must be considered and dealt with under any appropriate standards and regulations.

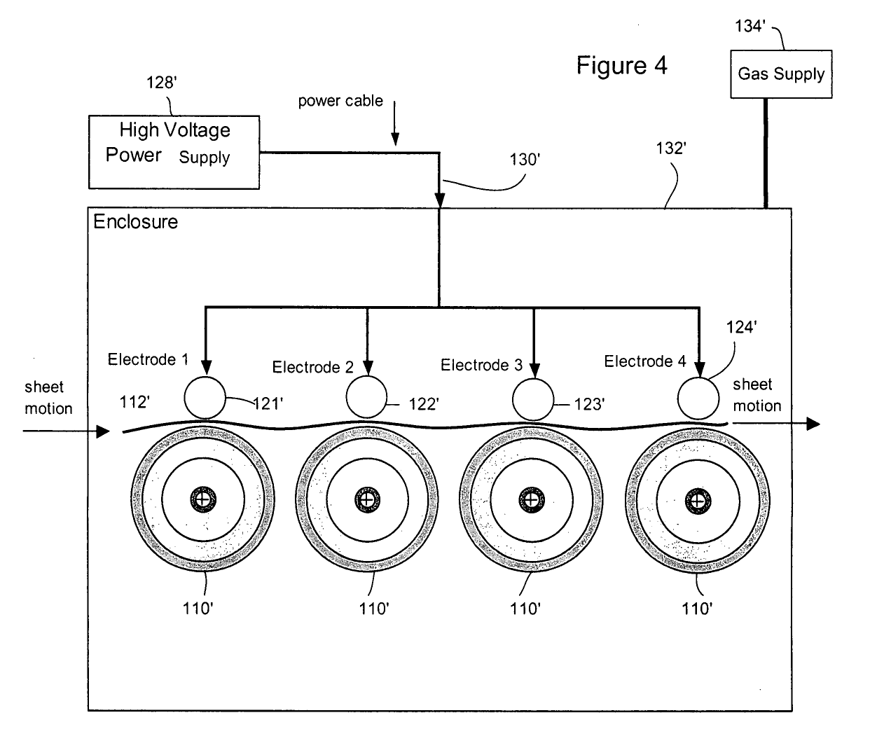

Referring now to FIG. 5, a flow chart in accordance with the present invention begins with a step 210, wherein a marking material is deposited on a receiver by a printing device printing any of a number of print methods, such as electrography, offset press, inkjet, laserjet, etc. In a step 220, the receiver with the marking material deposited thereon is then subject to surface treatment as described hereinbefore in a step 230. After surface treatment, the receiver is then put through another printing step 240 during which additional marking material is deposited thereon, in the form of an image or images or other. The second printing may be any of a number of printing techniques, such as electrography, offset press, inkjet, laserjet, etc. The marking material may be any of a number of known marking materials, such as toner, ink, etc. The toners may be many compositions, such as styrene acrylate, polyester binders, magnetic ink character recognition (MICR) toners, limited coalescent toners, liquid toners, clear toners, etc.

The surface energy of a test sample surface can be measured in a variety of ways, such as by contacting the sample surface with droplets of any of a variety of types of fluids, and measuring the angle at which the droplet wets the sample over time. A low surface energy sample surface which does not interact well with the fluid is not wetted to a large extent, so the droplet of fluid remains as a fairly spherical drop with small contact area and large tangent angle at the edges of the droplet relative to the horizontal sample surface. In contrast, a high surface energy sample surface, especially one which interacts with the fluid, will be more wetted by the fluid, resulting in a more spread out and flattened droplet, having a higher contact area and a relatively lower tangent angle of contact with the sample surface. A specialized microscopic viewer with a reticle (called a goniometer) is used to magnify an image of the droplet on the surface and measure the angle of contact at the droplet edge between the surface and a line tangent to the droplet at the point of contact. Various fluids are used for measuring the sample surface energy, not only because they have different, well-established intrinsic surface energies themselves, but also because the type of fluid determines the interaction with the sample. A fluid such as pure water has a relatively high surface energy and is also considered a polar compound, will only wet surfaces with a relatively high surface energy, particularly ones which also have a polar character leading to polar-to-polar interactions at the surface. Fluids such as aliphatic hydrocarbons (eg. hexane, octane, decane) have a relatively lower surface energy and are considered non-polar compounds. Other fluids can be used such as water or alcohols, or mixtures thereof, and can contain dissolved materials such as iodomethane. By using both polar and non-polar types of fluids for measuring wettability of the surface, the surface energy may be considered in terms of polar and non-polar (or “dispersive”) components. Calculations of surface energy from the measured contact angles with different fluids are well known to those skilled in the art. These measurements can be useful to better understand and ultimately predict the ability of various materials to wet and hence adhere to samples, especially after surface treatment.

Samples of media pre-printed with offset printing ink (examples are Superior and Kueffel&Esser brand name inks) are generally not wetted well by water in the ink-covered areas, since offset inks are oil-like materials in order to properly function in the offset printing process. Offset inks generally contain non-polar compounds as binders and solvents. These samples remain poorly wetted by water even after the ink has dried adequately for normal handling without smearing. They are considered as having low surface energy, particularly the polar component of surface energy. However, when surface energy is measured with non-polar fluids, they are wettable, so they have a somewhat higher dispersive surface energy component than polar component. When pre-printed samples are treated with corona discharge treatment (or a variety of other different surface treatments), the sample surface is coated or changed in some way which increases predominantly the water wettability, or polar component of surface energy. The change is fairly quick, as samples measured within a few minutes after treatment are changed, and the increase is persistent for hours, if not days, depending on a variety of factors, such as paper type, ink type, ink layer thickness and dryness, CDT treatment level (power and time), ambient gas composition around the sample during treatment, ambient temperature and humidity level, airflow, ozone concentration, etc.

As an example, testing was done on pre-printed samples with blue, red, and yellow K&E ink on 80 lb Domtar Luna Gloss paper. They were treated at 800 W power for 0, 20, and 60 sec times of rotation in the CDT device. Since 10% of the time was in the plasma during rotation on a treatment roller (plasma to circumference ratio 1:10), the times in the plasma were actually about 0, 2, and 6 sec. Surface energy was measured with water and iodomethane by Deb Richardson. Similarly treated samples were imaged with D1 toner in a Digimaster 9150 printer.

The following data show the benefit on toner adhesion from CDT treatment. These are the changes in surface energy which Jason Morgan and Deb Richardson measured within about 30 min after treatment, compared to the resulting toner adhesion after toner imaging, measured by measuring the width of a crack from folding and brushing the paper. The Total surface energy increased by at least 12.5 mN/m for the three ink types with 20 sec treatment, and was above 52.6 mN/m overall after 20 sec. The polar component is increasing the most dramatically, by at least 20.3 mN/m for 20 sec treatment, and was at least 21.1 mN/m. The dispersive component decreases somewhat at 20 sec, but increases again at 60 sec while adhesion increased for both, indicating a poor correlation with this component.

Blue Ink

| CDT | | | | | |
|---|---|---|---|---|---|
| Rotation | Blue | Blue | Blue | Crackwidth | Crackwidth |
| Time | Dispersive | Polar | Total | Average | Std Dev |
| (sec) | (mN/m) | (mN/m) | (mN/m) | (microns) | (microns) |
| 0 | 38.5 | 0.4 | 38.9 | 434.0 | 135 |
| 20 | 30 | 27.4 | 57.4 | 212 | 29 |
| 60 | 33.2 | 36.6 | 69.8 | 119 | 20 |

Red Ink

| CDT | | | | | |
|---|---|---|---|---|---|
| Rotation | Red | Red | Red | Crackwidth | Crackwidth |
| Time | Dispersive | Polar | Total | Average | Std Dev |
| (sec) | (mN/m) | (mN/m) | (mN/m) | (microns) | (microns) |
| 0 | 39.8 | 0.7 | 40.5 | 645 | 135 |
| 20 | 28.2 | 32.4 | 60.6 | 308 | 47 |
| 60 | 38.2 | 23.6 | 61.8 | 167 | 20 |

Yellow Ink

| CDT | | | | | |
|---|---|---|---|---|---|
| Rotation | Yellow | Yellow | Yellow | Crackwidth | Crackwidth |
| Time | Dispersive | Polar | Total | Average | Std Dev |
| (sec) | (mN/m) | (mN/m) | (mN/m) | (microns) | (microns) |
| 0 | 39.3 | 0.8 | 40.1 | 518 | 127 |
| 20 | 31.5 | 21.1 | 52.6 | 222 | 41 |
| 60 | 37.7 | 24.4 | 62.1 | 111 | 17 |

The present media treatment technique is particularly advantageous for electrophotographic printing on preprinted media. Other forms of printing, such as laser jet, offset press, etc. may be utilized also for printing on preprinted media also.

The present invention relates to a method of printing comprising the steps of marking the surface of a media with a first marking material; treating the surface of the media to increase the surface energy thereof; and, marking the surface of the media with a second marking material after treating.

Although the invention has been shown and described with exemplary embodiments thereof, it should be understood by those skilled in the art that the foregoing and various other changes, omissions and additions may be made therein and thereto without departing from the spirit and scope of the invention.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

1. A method of printing comprising the steps of:
marking the surface of a media with a first marking material;
treating the surface of the media to increase the surface energy thereof; and,
marking the surface of the media with a second marking material after treating.

2. The method of claim 1, wherein treating comprises corona discharge treatment.

3. The method of claim 1, wherein printing comprises electrostatographic printing.

4. The method of claim 1, wherein treating comprises plasma treatment.

5. The method of claim 1, wherein treating comprises ozone treatment

6. The method of claim 1, wherein treating comprises UV treatment.

7. The method of claim 1, wherein treating comprises electron-beam treatment.

8. The method of claim 1, wherein treating comprises electron beam radiation treatment.

9. The method of claim 1, wherein the first marking material is ink and the second marking material is toner.

10. The method of claim 1, wherein the second marking material is comprised of toner.

11. The method of claim 1, wherein treating comprises heat treatment.

12. The method of claim 1, wherein treating comprises heating the media while treating.

13. The method of claim 1, wherein the media is heavy media.

14. The method of claim 1, wherein treating comprises driving off the volatiles from the media.

15. A print apparatus comprising:
a printer to mark the surface of a media with a first marking material;
a surface treatment device to treat the surface of the media to increase the surface energy thereof; and
a printer to mark the surface of a media with a second marking material after treating.

16. A print apparatus according to claim 15, wherein treating comprises corona discharge treatment.

17. A print apparatus according to claim 15, wherein marking comprises electrostatographic printing.

18. A print apparatus according to claim 15, wherein treating comprises plasma treatment.

19. A print apparatus according to claim 15, wherein treating comprises ozone treatment.

20. A print apparatus according to claim 15, wherein treating comprises UV treatment.

21. A print apparatus according to claim 15, wherein treating comprises electron-beam treatment.

22. A print apparatus according to claim 15, wherein treating comprises electron beam radiation treatment.

23. A print apparatus according to claim 15, wherein the first marking material is ink and the second marking material is toner.

24. A print apparatus according to claim 15, wherein the first marking material is color toner and the second marking material is black toner.

25. A print apparatus according to claim 15, wherein treating comprises heat treatment.

26. A print apparatus according to claim 15, wherein treating comprises heating the media while treating.

27. A print apparatus according to claim 15, wherein the media is heavy media.

28. A print apparatus according to claim 15, wherein treating comprises driving off the volatiles from the media.

29. A method of printing comprising the steps of:
marking the surface of a media with a first marking material;
treating the surface of the media to increase the surface energy thereof; and
marking the surface of the media with toner in an electrographic print engine after treating.

30. A print apparatus for printing on media comprising:
a printer to mark the surface of a media with a first marking material;
a surface treatment device to treat the surface of the media to increase the surface energy thereof; and
an electrographic print engine to provide toner on the surface of a media with a second marking material after treating.
